(19) United States
(12) Patent Application Publication
(10) Pub. No.: US 2010/0117552 A1
(43) Pub. Date: May 13, 2010

(54) Illumination Apparatus

(76) Inventor: Young Hwan Lee, Seoul (KR)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/615,112

(22) Filed: Nov. 9, 2009

Related U.S. Application Data
(60) Provisional application No. 61/113,527, filed on Nov. 11, 2008.

(30) Foreign Application Priority Data
Nov. 11, 2008 (KR) 10-2008-0111895

(51) Int. Cl. H05B 41/26; H05B 41/36; H05B 37/02

(52) U.S. Cl. 315/287; 315/291; 315/294

(57) ABSTRACT

An illumination apparatus includes an adapter configured to be inserted into an incandescent lamp socket; and a light emitting device illumination part that is coupled detachably and electrically to the adapter to emit light according to the driving power from the adapter. The incandescent lamp socket has a coupling groove, including an injection groove and a rotation groove. The adapter in configured to convert alternating power to driving power.

The present application claims priority under 35 U.S.C. §119(e) of Korean Patent Application No. 10-2008-0111895 (filed on Nov. 11, 2008) and U.S. Provisional Application No. 61/113,527 (filed on Nov. 11, 2008) which are hereby incorporated by reference in its entirety.

### BACKGROUND

### Description of the Related Art

Embodiments of the invention relate to an illumination apparatus.

At the present time, a fluorescent lamp or an incandescent lamp has been widely used as an illumination apparatus. In particular, the fluorescent lamp has low power consumption and high brightness so that it has been widely used at office or at home.

Meanwhile, an illumination apparatus that replaces the fluorescent lamp or the incandescent lamp has been recently developed and, representatively, an illumination apparatus using a light emitting diode (LED) has been introduced.

However, in the case of the illumination apparatus using the LED, it is driven with different voltage from the fluorescent lamp or the incandescent lamp, causing a problem that all of power supply apparatus including conventionally installed sockets should be replaced when using the illumination apparatus using the LED.

### SUMMARY OF THE INVENTION

The embodiments provide an illumination apparatus with a new structure using an LED or an organic LED (OLED).

The embodiments provide an illumination apparatus using an LED or OLED that can be used without replacing a conventional power supply apparatus installed for a fluorescent or incandescent lamp.

The embodiments provide an illumination apparatus that can compatibly use various light emitting device illumination parts by detachably installing an adapter and a light emitting device illumination part.

The embodiments provide an illumination apparatus that can be used by firmly coupling an adapter to a light emitting device illumination part.

The embodiments provide an illumination apparatus in which an adapter can be firmly coupled to a socket.

An illumination apparatus according to various embodiments includes: an adapter that is configured to be inserted into an incandescent lamp socket that has a coupling groove including an injection groove and a rotation groove, the adapter being configured to convert alternating power to driving power; and a light emitting device illumination part that configured to be detachably and electrically coupled to the adapter and to emit light according to the driving power from the adapter.

An illumination apparatus according to various embodiments includes: an adapter configured to be detachably and electrically connected to an incandescent lamp socket and to convert alternating power to driving power; and a light emitting device illumination part that has a coupling projection part that is attachable and detachable to the adapter and that is configured to emit light according to the driving power from the adapter.

An illumination apparatus according to various embodiments includes: a connection terminal configured to be connected detachably and electrically to an incandescent lamp socket; an AC-DC converter that converts an AC voltage from the connection terminal into a DC voltage; a regulator that receives the DC voltage from the AC-DC converter and outputs a constant DC voltage; a light emitting device driver that generates one or more driving pulses from the constant DC voltage from the regulator; a power terminal groove or socket that provides the driving pulse(s) from the light emitting device driver; a power terminal that has a coupling projection part configured to be coupled detachably to the power terminal groove of the adapter; a housing coupled or attached to the power terminal; a substrate in the housing, provided with a power supply circuit; and a light emitting device illumination part comprising a plurality of light emitting devices on the substrate.

### BRIEF DESCRIPTION OF THE DRAWINGS

FIG. 1 is a diagram explaining an illumination apparatus according to an embodiment.

FIGS. 2 and 3 are cross-sectional views of an adapter in the illumination apparatus according to the embodiment.

FIG. 4 is a diagram explaining the adapter in the illumination apparatus according to the first embodiment.

FIG. 5 is a diagram showing the AC-DC converter and the regulator of the adapter in the illumination apparatus according to the first embodiment.

FIG. 6 is a diagram explaining an illumination apparatus according to another embodiment.

FIG. 7 is a diagram explaining an illumination apparatus according to still another embodiment.

### DETAILED DESCRIPTION OF THE EMBODIMENTS

In the drawings, the thickness or size of each layer is exaggerated, omitted or schematically illustrated for the convenience and clarity of explanation. Also, the size of each constituent does not completely reflect its actual size.

Hereinafter, an illumination apparatus according to various embodiments will be described with reference to the accompanying drawings.

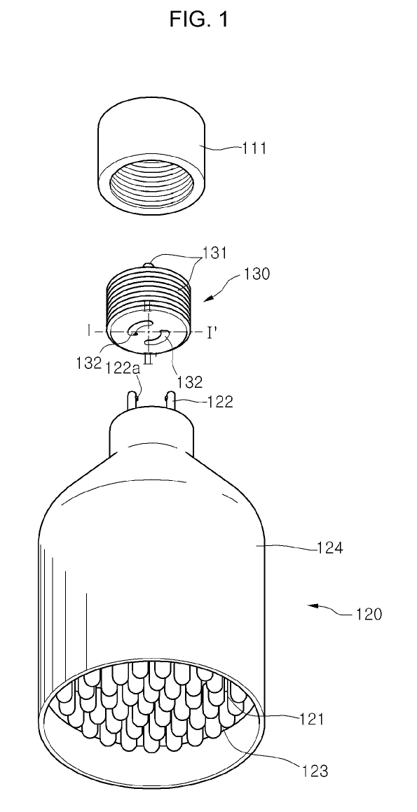

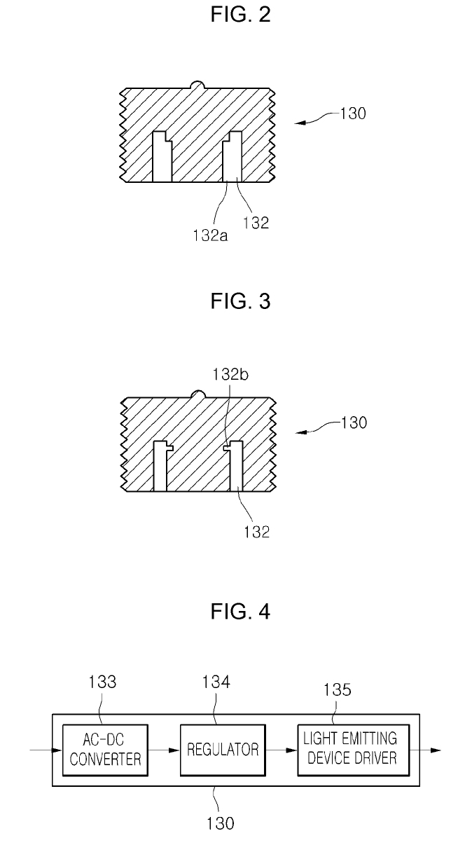

FIG. 1 is a diagram explaining an illumination apparatus according to an embodiment, and FIGS. 2 and 3 are cross-sectional views of an adapter in the illumination apparatus according to the embodiment.

First, referring to FIG. 1, the illumination apparatus according to the embodiments includes an adapter 130 that can be coupled to a socket 111 at which an incandescent lamp can be installed and a light emitting device illumination part 120 that is coupled detachably to the adapter 30.

The adapter 130 has a connection terminal 131 formed in a shape that can be coupled to the socket 111, having a spiral projection, and connected electrically to the socket 111, and a power terminal groove 132 to which the light emitting device illumination part 120 is coupled to be electrically connected.

The light emitting device illumination part 120 includes a power terminal 122 inserted into the power terminal groove 132 to be electrically connected, a housing 124 at which the power terminal 122 is installed, a substrate 123 coupled to the housing 124, and a plurality of light emitting devices 121 installed on the substrate 123. The light emitting device illumination part 120 may further include a cover 140 coupled to the housing 124 in order to protect the plurality of light emitting devices 121.

At this time, the light emitting device illumination part 120 has a coupling projection part 122a, making it possible to be firmly coupled to the adapter 130.

For example, FIG. 2 is a cross-sectional view taken along lines I-I′ of FIG. 1, and FIG. 3 is a cross-sectional view taken along lines II-II′ of FIG. 1. FIG. 2 is a cross-sectional view of the initial time point of coupling when the light emitting device illumination part 120 is inserted into the adapter 130. FIG. 3 is a cross-sectional view of the time point when the light emitting device illumination part 120 is half-turned at about 90° after being inserted into the adapter 130.

As shown in the embodiment, the adapter 130 includes a coupling groove 132b coupled to the coupling projection part 122a of the light emitting device illumination part 120, making it possible to provide an illumination apparatus that can be installed by firmly coupling the adapter 130 to the light emitting device illumination part 120.

The substrate 123 may be a printed circuit board (PCB) on which a circuit pattern for providing power to the light emitting devices 121 is formed. Also, the substrate 123 may be a substrate that a wiring for providing power to the light emitting devices 121 is installed on a plastic instrument. The substrate 123 is connected electrically to the power terminal 122.

Moreover, a reflective coating layer (not shown) may be formed on the surface of the substrate 123, making it possible to increase efficiency of light emitted from the light emitting devices 121 by coating it with silver (Ag) or aluminum (Al).

In the embodiment, the substrate 123 is formed in a plate shape to be inserted into the inside of the housing 124. Therefore, when the cover 140 is coupled to the housing 124, the substrate 123 and the light emitting devices 121 installed on the substrate 123 are surrounded by the housing 124 and the cover 140.

The plurality of light emitting devices 121 may include LED or OLED that emit red, blue, and green light, and may also include LED or OLED that emit white light.

The cover may be formed of transparent plastic material, and may also be formed of plastic with various colors such as red, green, blue, etc., according to designs. Also, the cover may be formed of translucent material and in this case, it may also provide an illumination with a soft atmosphere.

As the light emitting device illumination part 120 is coupled to the adapter 130, the illumination apparatus according to the embodiments can be installed at the socket 111 at which the conventional incandescent lamp is installed.

Moreover, as the adapter 130 converts AC power applied to the conventional incandescent lamp into DC power, the illumination apparatus according to the embodiments allows the light emitting devices 121 to be driven.

Therefore, although a power supply apparatus including the socket 111 where the conventional incandescent lamp is installed is not replaced, an illumination apparatus using LED or OLED can be used.

In particular, since the light emitting device illumination part 120 and the adapter 130 are detachably installed, when defects are generated on the light emitting device illumination part 120 or the adapter 130, only the light emitting device illumination part 120 or the adapter 130 where the defects are generated can be replaced, having low maintenance costs.

Moreover, since the light emitting device illumination part 120 and the adapter 130 are detachably installed, illuminations with various atmospheres can be provided by replacing only the light emitting device illumination part 120.

Referring to FIG. 4, the adapter 130 includes an AC-DC converter 133, a regulator 134, and a light emitting device driver 135. the light emitting device driver 135 may be a driver that drives the light emitting devices 121 formed of LED or OLED.

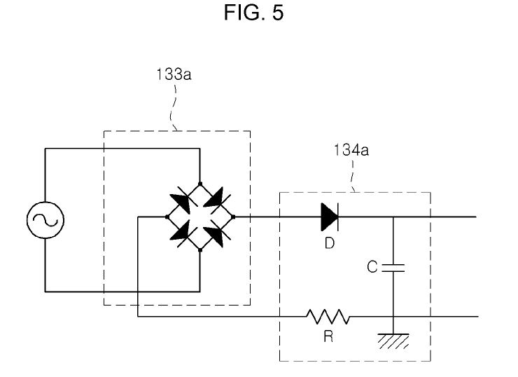

The AC-DC converter 133 converts AC power supplied through the socket 111 into DC power, the regulator 134 allows the DC power output from the AC-DC converter 133 to be output as constant DC voltage, and the light emitting device driver 135 outputs the DC voltage supplied from the regulator 134 as driving pulse proper in driving the plurality of light emitting devices 121. For example, as shown in FIG. 5, the adapter 130 includes a bridge rectifier 133a and a smoothing circuit 134a to allow constant DC voltage to be output.

Therefore, the light emitting device illumination part 120 can also be used in the power supply apparatus for the conventional incandescent lamp to which AC power is supplied, by the adapter 130 including the AC-DC convert 133, the regulator 134, and the light emitting device driver 135.

In other words, the illumination apparatus according to the embodiments installs the adapter 30, making it possible to use the light emitting device illumination part 20, while using the conventional power supply apparatus as it is.

Moreover, since the adapter 30 and the light emitting device illumination part 20 are detachable, the illumination apparatus can be used to be connected to only the light emitting device illumination part 20 by separating the adapter 30 from the light emitting device illumination part 20 where the power supply apparatus for the light emitting device illumination part 20 is installed.

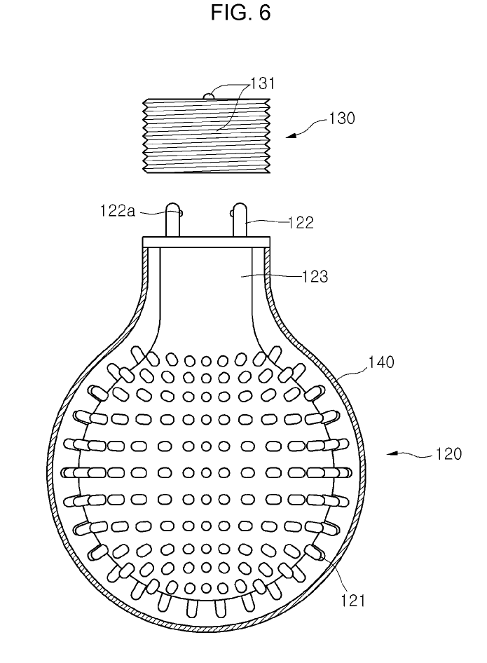

FIG. 6 is a diagram explaining an illumination apparatus according to another embodiment.

When explaining the illumination apparatus of FIG. 6, the explanation overlapped with the contents explained in FIG. 2 will be omitted.

Referring to FIG. 6, a light emitting device illumination part 120 includes a substrate 123 formed in a spherical shape and a plurality of light emitting devices formed at the spherical surface of the substrate 123, wherein a power terminal 122 is installed at one side of the substrate 123. Also, a cover 140 that surrounds the substrate 123 and is spaced from the light emitting devices 121 at a predetermined interval may further be included.

The light emitting device illumination part 120 installs the plurality of light emitting devices 121 at the surface of the substrate 123 formed in a spherical shape, making it possible to provide illumination to positions having a wide angle.

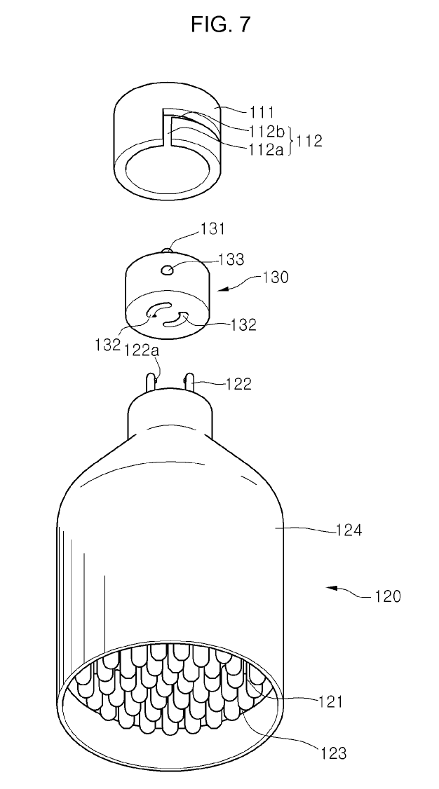

FIG. 7 is a diagram explaining an illumination apparatus according to still another embodiment.

When explaining the illumination apparatus of FIG.7, the explanation overlapped with the contents explained before will be omitted.

Referring to FIG. 7, an incandescent lamp socket 111 may have a coupling groove 112. At this time, the coupling groove 112 may include an injection groove 112a and a rotation groove 112b.

The injection groove 112a is vertically extended and the rotation groove 112b is horizontally extended along an outer circumferential surface of the incandescent lamp socket 111. In other words, the injection groove 112a and the rotation groove 112b are extended to be vertical to each other.

The adapter 130 is formed to be coupleable to the incandescent lamp socket 111 that has the coupling groove 112. For example, the adapter 130 may further include a projection part 133 that is detachable to the coupling groove 112 of the socket 111.

For example, the projection part 133 of the adapter is inserted into the coupling groove 112 and then the adapter 130 is rotated, thereby making it possible to be firmly coupled. In other words, after the projection part 133 of the adapter is inserted into the injection groove 112a of the socket, the adapter 130 is half-turned at 90° through the rotation groove 112b, having an advantage in that the adapter 130 can be firmly coupled to the socket 11.

Moreover, the adapter 130 includes the coupling groove 132b coupled to the coupling projection part 122a of the light emitting device illumination part 120, thereby providing the illumination apparatus that can be used by firmly coupling the adapter 130 to the light emitting device illumination part 120. However, various modifications can be made in the coupling method between the adapter 130 and the light emitting device illumination part 12.

The embodiments can provide the illumination apparatus with a new structure using LED or OLED.

The embodiments can provide the illumination apparatus using LED or OLED that can be used without replacing the conventional power supply apparatus installed for the fluorescent lamp.

The embodiments can provide the illumination apparatus that can compatibly use various light emitting device illumination parts by detachably installing the adapter and the light emitting device illumination part.

The embodiments can provide the illumination apparatus that can be used by firmly coupling the adapter to the light emitting device illumination part.

The embodiments provides the illumination apparatus in which the adapter can be firmly coupled to the socket.

Any reference in this specification to “one embodiment,” “an embodiment,” “example embodiment,” etc., means that a particular feature, structure, or characteristic described in connection with the embodiments is included in at least one embodiment of the invention. The appearances of such phrases in various places in the specification are not necessarily all referring to the same embodiment. Further, when a particular feature, structure, or characteristic is described in connection with any embodiment, it is within the purview of one skilled in the art to effect such feature, structure, or characteristic in connection with other embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An illumination apparatus comprising:
an adapter configured to be inserted into an incandescent lamp socket, the incandescent lamp socket having a coupling groove including an injection groove and a rotation groove, the adapter being configured to convert alternating power to driving power; and
a light emitting device illumination part configured to be coupled detachably and electrically to the adapter and to emit light according to the driving power from the adapter.

2. The illumination apparatus according to claim 1, wherein the adapter further includes a projection part that is attachable and detachable to the adapter through the coupling groove of the socket.

3. The illumination apparatus according to claim 2, wherein the projection part is configured to be inserted into the injection groove of the socket and then rotated in the rotation groove of the socket.

4. The illumination apparatus according to claim 3, wherein the rotation groove is angled from the end of the injection groove.

5. The illumination apparatus according to claim 1, wherein the light emitting device illumination part has a coupling projection part configured to be coupled detachably to the adapter.

6. The illumination apparatus according to claim 5, wherein the adapter includes a coupling groove or socket adapted to be coupled to the coupling projection part.

7. The illumination apparatus according to claim 1, wherein the adapter includes:
an AC-DC converter that converts an AC voltage into a DC voltage;
a regulator that receives the voltage from the AC-DC converter and outputs a constant DC voltage; and
a light emitting device driver that outputs the constant DC voltage from the regulator as one or more driving pulses.

8. The illumination apparatus according to claim 1, comprising:
a power terminal configured to be coupled and electrically connected to the adapter;
a housing connected to and/or surrounding the power terminal;
a substrate in the housing; and
a plurality of light emitting devices on the substrate.

9. The illumination apparatus according to claim 8, wherein the light emitting devices comprise light-emitting diodes (LEDs) or organic light-emitting diodes (OLEDs).

10. An illumination apparatus comprising:
an adapter configured to be connected detachably and electrically to an incandescent lamp socket, the adapter being configured to convert alternating power to driving power; and
a light emitting device illumination part that has a coupling projection part that is attachable and detachable to the adapter and that emits light according to the driving power from the adapter.

11. The illumination apparatus according to claim 10, wherein the adapter includes a coupling groove or socket configured to be coupled to the coupling projection part.

12. The illumination apparatus according to claim 10, wherein the adapter includes:
an AC-DC converter that converts an AC voltage into a DC voltage;
a regulator that receives the voltage from the AC-DC converter and outputs a constant DC voltage; and
a light emitting device driver that outputs the constant DC voltage from the regulator as one or more driving pulses.

13. The illumination apparatus according to claim 10, wherein the adapter includes:
a connection terminal having an external surface with a spiral projection, configured to be coupled to and connected electrically to the incandescent lamp socket; and
a power terminal groove or socket that is configured to be coupled to the light emitting device illumination part.

14. The illumination apparatus according to claim 10, comprising:
a power terminal configured to be electrically connected and/or coupled to the adapter;
a housing attached to and/or surrounding the power terminal;
a substrate in the housing; and
a plurality of light emitting devices on the substrate.

15. The illumination apparatus according to claim 14, further comprising:
a cover that configured to be attached to the housing to protect the plurality of light emitting devices.

16. The illumination apparatus according to claim 14, wherein the light emitting devices each comprise a LED or OLED.

17. An illumination apparatus comprising:
a connection terminal configured to be connected detachably and electrically to an incandescent lamp socket;
an AC-DC converter that converts an AC voltage from the connection terminal into a DC voltage;
a regulator that receives the DC voltage from the AC-DC converter and outputs a constant DC voltage;
a light emitting device driver that generates one or more driving pulses from the constant DC voltage from the regulator;
a power terminal groove or socket that provides the driving pulse(s) from the light emitting device driver;
a power terminal that has a coupling projection part configured to be coupled detachably to the power terminal groove or socket;
a housing attached or coupled to the power terminal;
a substrate in the housing having a power supply circuit therein or thereon; and
a light emitting device illumination part comprising a plurality of light emitting devices on the substrate.

18. The illumination apparatus according to claim 17, wherein the adapter includes a coupling groove or socket adapted to be coupled to the coupling projection part.

19. The illumination apparatus according to claim 17, wherein the light emitting devices each comprise an LED or OLED.
